(19) United States
(12) Patent Application Publication
(10) Pub. No.: US 2024/0005340 A1
(43) Pub. Date: Jan. 4, 2024

(54) AUTOMATIC IDENTIFICATION AND CREATION OF AFFILIATES

(71) Applicant: Archive Technologies, Inc., Miami, FL (US)

(72) Inventors: Geoffrey Woo, Miami, FL (US); Paul Benigeri, Miami, FL (US); Evgeniy Belorusets, Minsk (BY)

(21) Appl. No.: 17/856,431

(22) Filed: Jul. 1, 2022

(51) Int. Cl. G06Q 30/02

(52) U.S. Cl. CPC G06Q 30/0201; G06Q 30/0241

(57) ABSTRACT

Systems and methods for Automatic Identification and Creation of Affiliates are provided. For example, a system accesses a model that identifies patterns corresponding to consumer brand markers. The system then analyzes a first set of user-generated content (UGC) items within a dialogic network to identify a signifier corresponding with a consumer brand marker. The system can cluster a subset of the first set of UGC items including at least two of the plurality of UGC items. A message can be generated including instructions for establishing an affiliate-sponsor relationship.

### TECHNICAL FIELD

This document pertains generally, but not by way of limitation, to content organization. More particularly, this document pertains to systems and methods for automated identification of relevant user-generated content.

### BACKGROUND

Marketing on social media platforms can be challenging, requiring deviation from more conventional marketing techniques. To emphasize a brand's products, the brand must stand out from the white noise that a target audience inherently experiences online. Increasingly, ecommerce customers are responding to a more authentic approach. For example, user-generated content (UGC) directed towards a product or a brand can be very valuable for use as a marketing material.

User-generated content (UGC) refers to any sort of digital content customers share online and brands repost. These kinds of content can include, for example, images, blog comments, blog posts, videos, or product reviews. Experienced social media managers and marketers use UGC in their marketing campaigns to add a feel of authenticity to their social media feed. Taking advantage of UGC can help them save time that they would otherwise spend themselves on creating original content, such as organizing photoshoots or creating commercials and advertisement campaigns. It is also generally understood that more people trust recommendations from people within their own personal network than advertisements on branded websites. Additionally, using UGC can also help promote a development of an online community surrounding the brand. With UGC, brands can engage with their community and create a stronger bond with their target audience. For example, by using UGC, brands give their customers the opportunity to tell stories and be heard, which is something brand-generated content may neglect to offer.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A depicts an example of a user generated content (UGC) identification system, including a user interface for a content review application.

FIG. 1B depicts a messaging interface of a UGC identification system.

FIG. 2 is a network diagram illustrating a network environment suitable for sharing content, curating recommendations, and distributing the curated recommendations across a social network and across multiple category areas and media units.

FIG. 3 is a block diagram illustrating components of the content review application server, according to some example embodiments.

FIG. 4 illustrates an exemplary model machine learning engine for use in identifying relevant user-generated content.

FIG. 5 is a flowchart depicting an example of a process flow to collect conversion data.

FIG. 6 is a flowchart showing a method of identifying user-generated content related to a consumer brand.

FIG. 7 is a block diagram illustrating components of a machine, according to some example embodiments.

FIG. 8 is a block diagram illustrating a mobile device, according to some example embodiments.

### DETAILED DESCRIPTION

Acquiring initial customers of a consumer brand can be difficult and expensive. Technological advances and stratification of media consumption among populations has reduced the effectiveness of a widely-directed advertisement campaign. One marketing solution is user-generated content (UGC). UGC can help enable a community built around a consumer brand co-sell with the brand and at least partially replace the role of traditional marketers and salespeople. This type of approach can be advantageous to a consumer brand where the cost of digital advertising is prohibitive and will not yield a desired result. Today, UGC campaigns are one of the most trusted forms of marketing. People believe that content creators and Instagram influencers share helpful and effective products, so they rely on those recommendations. This illustrates the positive relationship between UGC marketing, trust, and purchase intention. For instance, when a consumer, such as an influencer on social media references a product, other members of their network may start to view the brand as both appealing and trustworthy due to the association with the influencer.

Some user generated content can be ephemeral, such as vanishing from the social media platform after 24 hours. This time constraint burdens brands looking to identify and collect UGC related to their brand. Often, hundreds of potential assets are created daily by influencers and customers, and a potentially valuable portion of the content rapidly disappears. In an approach to collecting UGC related to a brand, media units can be manually browsed for relevant content. If relevant content is identified in browsing, the content can be manually screen-shotted or downloaded from a social media platform. This approach can be challenging as it can be time-consuming to search for relevant content, especially where the user generator has not themselves included a brand-identifier as a part of their content posting on the social media platform. Further, a brand generally has a short time period to perform this searching and must do it constantly, such as daily, to collect UGC over a length of time. Further, in an instance where the brand attempts to quickly find UGC, such as for a specific marketing purpose with a quick-turn deadline, many of the previously-posted, potential UGC items will have expired and cannot be included in the search.

Example embodiments provide systems and methods for automatically identifying, collecting, and archiving UGC relevant to a consumer brand. For example, a system can detect or identify UGC corresponding to a specific consumer brand or a subject related thereto. The system can identify UGC (e.g., ephemeral digital media including an expiration window), based on specific tags, hashtags, or content identification using a model. Upon detection and storage, the system can include or use natural language generation to automate email or a direct message to negotiate an affiliate marketing contract or an affiliate-sponsor relationship with an individual user account corresponding to the identified UGC. For example, the automated email or message can include incentives including samples, discounts, monetary bonuses, or tokens. The system can generate a unique affiliate link for each new affiliate user account, and an individual unique affiliate link can be used to credit or track downstream sales resulting from accessing the link. Cookies and other techniques can be used such as to track persistent user state to give credit to the referring affiliate over some fixed parameter set, including splitting revenues across multiple affiliates.

Managing UGC and creators thereof can help save time, effort, and money consumer brands spend generating content regularly. For example, having a repository of UGC media items to draw from can help a consumer brand better get their products noticed, such as by demonstrating authenticity with marketing efforts by using UGC. Performing repeated transactions with a single affiliate user account can also help alleviate a need to expend effort and expense to identify potential UGC creators. Systems and methods described herein can help a brand efficiently develop more personal advertising campaigns for their target audience.

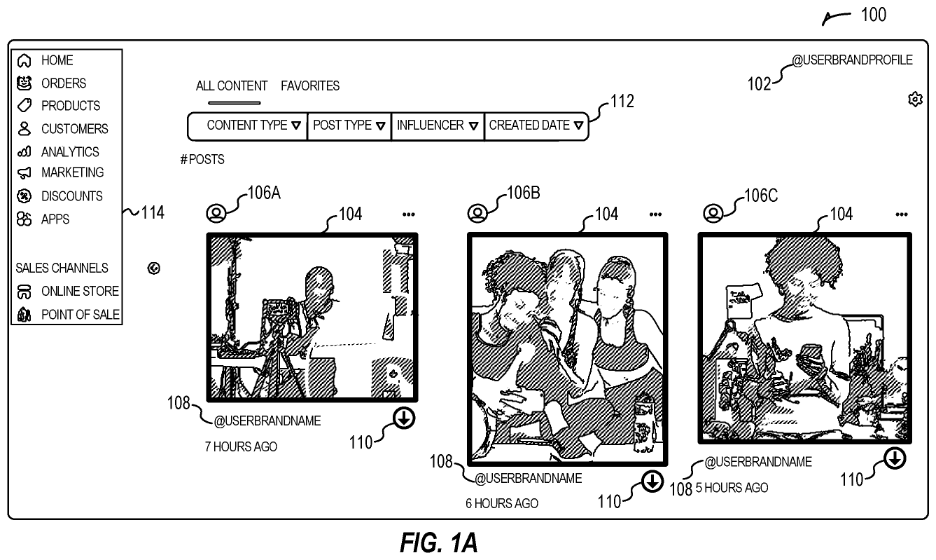

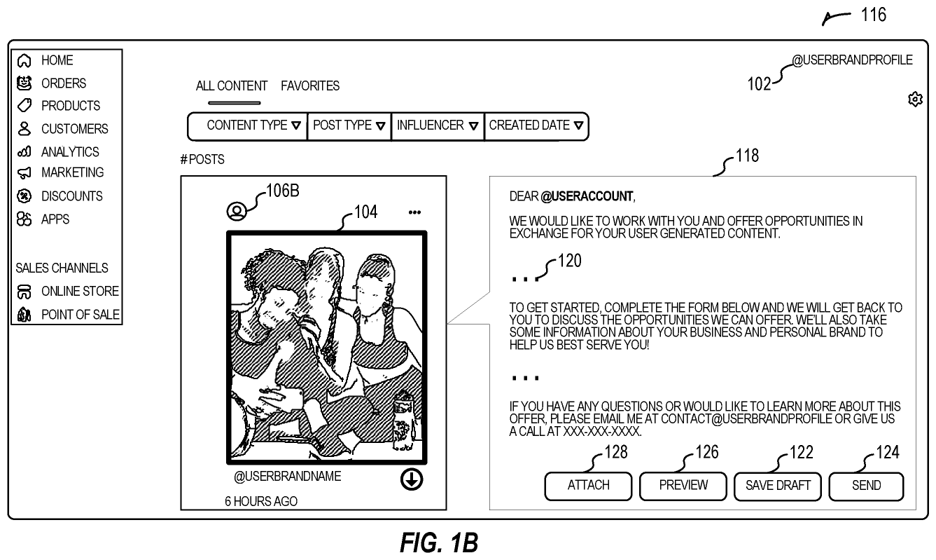

FIG. 1A depicts an example of a UGC identification system, including a user interface of a content review application 100. For example, the user interface can be provided by the content review application 100. The user interface can be displayed such as on a user device. The content review application can receive, via the user interface, UGC from one or more digital content platforms. In an example, the UGC can be transmitted over a network to an application server as will be discussed in more detail below. The content review application 100 is configured for sharing content and curating and distributing curated recommendations across a social network. The content review application 100 can be accessed by a user brand profile 102 (e.g., by an administrator or user associated with a brand). A user brand profile 102 can be a profile representing a consumer brand, such as a profile maintained or sponsored by a business entity of the consumer brand. The user brand profile 102 can use the content review application 100 such as to review identified or collected UGC items 104. Herein, the UGC items 104 can include images, videos, audio files, and/or other digital media. For example, the UGC items 104 can be identified or collected from a plurality of user accounts 106A, 106B, and 106C. In an example, an index of user accounts can be created, each user account 106 in the index corresponding to an individual UGC item 104 within the subset generated by a respective user account owner.

The UGC items 104 can be identified as related to a consumer brand by a model that identifies patterns or denotations 108 corresponding to a consumer brand marker. For example, the denotations 108 can be hashtags, user brand profile references, or keywords. The denotations 108 can be identified via a Boolean search. Also, the model can identify patterns such as via image recognition and for comparison to a brand signifier such as a brand logo.

The UGC can be gathered from a dialogic network, such as a social media platform. Herein, a “dialogic network” describes a network or an avenue of a network where both brands and consumers can communicate with relatively similar privileges and abilities. Examples of dialogic networks include Instagram™, TikTok™, Facebook™, Twitter™, Reddit™, Snapchat™, LinkedIn™, YouTube′, or Pinterest™. In an example, the content review application 100 can pool UGC items 104 retrieved from a plurality of dialogic networks, such as two or more social media platforms. In contrast, a “monologic network”, can be defined herein as a network where, for example, a brand posts an advertisement and wherein a consumer does not have a commensurate platform for communication. Examples of monologic networks include sponsored advertisements, brand website media, television advertisements, or printed media. It can be understood that some dialogic networks can include monologic network avenues. For instance, even though Instagram can enable both brands and consumers similar permissions for posting, a “verified” profile of a brand or a “sponsored” post therefrom can include communication that is generally monologic.

The content review application 100 can include a content downloader 110, such as a button or checkbox in the UI of the content review application 100 for selecting an individual UGC item 104. Also, the content review application 100 can include or use one or more filters 112 for selectively displaying potentially relevant UGC items 104 based on conditions specified by the user brand profile. For example, the filters 112 can include a content type, post type, influencer or user profile, creation or collection date, time stamp, media type, file type, brand signifier type, and the like. The content review application 100 can also include various selections 114 such as for managing individual affiliate user profiles 106, individual products, individual monologic network advertisement posts, sales, analytics, and the like.

In an example, a first set of UGC items 104 can be analyzed using the model. The first set can be analyzed within a dialogic network to identify a signifier corresponding with a consumer brand marker. A subset of the first set of UGC items 104 can be clustered using the model. For example, the subset can include at least two of the plurality of UGC items 104. An individual UGC item 104 from the subset can be transmitted, such as via a monologic network, as an advertisement for the consumer brand. For example, the content review application 100 can include one or more selections 114 for transmitting an individual UGC item 104 to be subsequently used as an advertisement for a consumer brand.

In an example, the model can be a machine learning model. The model can also be algorithmic. In an example, the machine learning model can be trained using training data from a second set of UGC items 104 each corresponding with a consumer brand marker. Here, an individual UGC item 104 in the second set of UGC items 104 can be assigned to an individual consumer brand marker.

In an example, a message directed to a respective user account owner can be automatically generated. For example, the automatic generation can be triggered upon user selection of an individual UGC item 104 within the content review application. Also, the automatic generation can be triggered upon use of the content downloader 110 for an individual UGC item 104. Automatically generating the message can include generating instructions for establishing an affiliate-sponsor relationship between an individual user account 106 and the consumer brand. For example, the automatically generated message can be transmitted to the individual user account 106. The automatically generated message can include or use a request from the consumer brand for a distribution right of the corresponding UGC item 104. The automatically generated message can include or use at least one automatically generated contractual offer from the consumer brand to an owner of the individual user account 106. For example, the contractual offer can include a proposal of a grant to the consumer brand of a distribution right of the corresponding UGC item 104 in exchange for an incentive to the owner of the individual user account 106. For instance, the incentive can include a monetary reward, an application-based currency unit, an application-based permission, or a user account award. The automatically generated message can include, for example, a user-account specific hyperlink directed to a product or a product sale page from the consumer brand. For example, the user-account specific hyperlink can be accessible to a third party such as to associate the specified user account 106 with third party traffic on the product sale page.

In an example, a plurality of user accounts (e.g., user accounts 106A, 106B, and 106C) within the index of user accounts can be valuated based on user data of the individual user account. For example, each user account 106 within the index can be valuated based on a specified rating system or with respect to one another. Valuating can include determining whether a user account parameter exists above a threshold for the individual user account 106 within the index of user accounts. For instance, the threshold can include one of: a minimum amount of followers of the individual user account 106, a minimum amount of UGC posts of the individual user account 106, a minimum amount of UGC shares of the individual user account 106, a minimum user account age of the individual user account 106, or a verification status (e.g., verification determined by the social media platform) of the individual user account 106. Valuating can also include analyzing a user account or a UGC item corresponding therewith based on at least one digital media attribute of a respective UGC item. For example; an individual UGC item or a family of UGC items can be analyzed based on at least one content lightning characteristic such as exposure, brightness, contrast, color profile, saturation, vibrance, white balance, or a combination thereof. Also, an individual UGC item or a family of UGC items can be analyzed based on at least one content playback length, content resolution, content file size, or content file format. An individual UGC item or a family of UGC items can be analyzed based on a characteristic of at least one a content audio waveform, such as a compression characteristic, a bit rate, a gain value, audio waveform noise, audio waveform clipping, or whether audio exists with respect to a video file. An individual UGC item or a family of UGC items can be analyzed based on at least one shared visual digital content 8characteristic included in a plurality of UGC items, such as a family of UGC items corresponding with an individual user account which usage rights are sought or obtained.

The threshold can be used to validate, qualify, and/or appraise an individual user account 106 for desirability or suitability for establishing an affiliate relationship therewith. For example, transmission of the automatically generated message can be prevented or impeded to an individual user account 106 lacking an account parameter above the threshold. The automatically generated message can include at least one automatically generated contractual offer from the consumer brand to an owner of the individual user account 106, wherein at least one term of the contractual offer can be established or adjusted based on the valuation for the individual user account 106. For example, the at least one term of the contractual offer can be a monetary offer amount and the valuation can be based on a social media engagement of the individual user account 106. Also, the valuation can be based on a predicted social media engagement of the individual user account or a predicted social media engagement of an individual UGC item corresponding with the individual user account. In an example, each user account 106 within the index of user accounts can be ranked relative to one another. Also, monetary incentives can be distributed disproportionately amongst the user accounts (e.g., user accounts 106A, 106B, and 106C) based on their respective rankings. For example, monetary incentives can be greater for user accounts 106 having a greater valuation and lower for user accounts having a lesser valuation.

FIG. 1B depicts a messaging interface of a UGC identification system. The messaging interface 116 includes a user input 118. For example, the messaging interface 116 can be included within the content review application 100 of FIG. 1A. The messaging interface 116 can be displayed within the content review application 100. For example, the messaging interface 116 can be displayed upon a user selection of an individual UGC item 104. Also, the messaging interface 116 can be provided as a separate submenu. The messaging interface 116 can include an interactive interface. The interactive interface can be used to direct a user (e.g., review an individual content item 104 for the user). The interactive interface can be selected, activated, or launched from the messaging interface 116. Also, the interactive interface can be provided as a separate submenu. The user input 118 can be any type of user input and includes any type of interaction with a user (e.g., direct user interaction with the user interface of the application). For example, the user input 118 can be a single keystroke, or can be an interface element such as a mouse or a touch interface (e.g., touch screen). The user input 118 can provide any type of control to be used by the content review application 100. Examples of user input 118 include, but are not limited to, a text entry of a text character, a button push, and the like. The user input 118 can be used to provide to the application a user-input parameter associated with the user.

The user input 118 allows a user account, such as the user brand profile 102, to compose or edit text or other digital media into a draft message 120 to an individual user account 106. For example, the messaging interface 116 can include an auto-generation unit for composing at least one draft message 120 to a potential affiliate user account 106. The draft message 120 can be composed based on predetermined draft shell content including a generic draft message 120 specific to the consumer brand corresponding with the user brand profile 102 or user-preference information received from the user brand profile 102. The message interface 116 can further include a message delivery system for delivering the draft message 120 to the user account 106. The message delivery system can be configured to deliver the draft message 120 by electronic mail. The message delivery system can also be configured to deliver the draft message 120 to an electronic bulletin board. In addition, the message delivery system can be configured to deliver the draft message 120 to a social networking website. The message delivery system can also be configured to deliver the draft message 120 to a voice-mail account of the user 106. For example, the message delivery system can include a save button 122 for saving the draft message or a send button 124 for conveying the draft message 120 to the user account 106. The message delivery system can further include a preview button 126 for previewing the draft message 120 or an attach file button 128 for attaching an additional file.

The draft message 120 can include a request from the user brand profile 102 for a distribution right of the corresponding UGC item. The distribution right can be an exclusive distribution right, or the right to distribute the UGC item by a certain channel, or other distribution rights. For example, if the UGC item is in a digital format, the distribution right can be an exclusive distribution right. If the UGC item is in an analog format, the distribution right can be the right to distribute the UGC item via a certain channel (e.g., television channel or radio channel). If the UGC item is multimedia, the distribution right can be the right to distribute the UGC item in one or more manners.

The draft message 120 can also include at least one automatically generated contractual offer from the user brand profile 102 and to an owner of the individual user account 106. In this instance, the automatic can be presented in one or more languages supported by the user brand profile 102, and can include terms and conditions that govern the offer. The draft message 120 can also include at least one manually selectable offer from the user brand profile 102 and to an owner of the individual user account 106. For example, the draft message 120 can also include a plurality of manually selectable offers from the user brand profile 102 and to an owner of the individual user account 106. The at least one manually selectable offer can be in addition to any other automatically generated offers. The automatically generated offer can also include at least one option relating to the offer, such as “accept the offer now”, “accept the offer next week”, “accept the offer after x weeks”, “accept the offer after x months”, “refuse the offer” or “decline the offer”, which can be presented in any order as desired. The owner of the individual user account 106 can accept or decline the offer without contacting the user brand profile 102. The draft message 120 can also include at least one option relating to the manual offer, such as “accept this offer now”, “accept this offer next week”, “accept this offer after x weeks”, “accept this offer after x months”, “decline this offer”, “decline this offer now” or “decline this offer next week”, which can be presented in any order as desired. In an example, the owner of the individual user account 106 can accept or decline the offer without further contacting the user brand profile 102.

In an example, the draft message 120 can also include an automatically generated, non-binding counter-offer from the user brand profile 102 to the owner of the individual user account 106 to be prepared as a draft message 120 for responding to a message from the user account 106, such as where the user account 106 proposes an offer or counter-offer to the user brand profile 102. The draft message 120 can also include a request to the owner of the individual user account 106 to execute at least one of the contractual offers in the draft message 120. The owner of the individual user account 106 can accept the counter-offer in the draft message 120, thereby generating a binding contractual offer. The draft message 120 can include further contractual offers and counter-offers to facilitate further transactions between the owner of the user account 106 and the user brand profile 102. The method can further include an exchange of payment details among the respective consumer and individual brands. The exchange of payment details can include at least one non-binding transaction that is not necessarily included in the draft message 120. Alternatively, the exchange of payment details can include a draft message 120 and non-binding transactions. The non-binding transactions can include at least one payment that is made prior to the UGC transaction.

In an example, the at least one draft message 120 can include a user-account specific hyperlink directed to a product or a product sale page from the consumer brand corresponding with the user brand profile 102. The hyperlink can be provided by a product, service, organization, or store via the consumer brand such as a hypertext markup language (HTML) hyperlink directed to a product, service, organization, or store that the consumer brand has an associated relationship with. In another example, the at least one draft message 120 can include a user-account specific hyperlink directed to an associated page of a website. In yet another example, the at least one draft message 120 can include an draft advertisement or mock advertisement that relates to the at least one draft message 120 and the corresponding UGC item 104. In another example, the at least one draft message 120 can include a plurality of user-brand specific hyperlinks. The plurality of user-brand specific hyperlinks can correspond with different versions of the consumer brand profile for each consumer brand and can be directed to product, service, organization, or store pages that are associated with each respective consumer brand.

For example, the message interface 116 can further include a message receiving unit for receiving a reply to the draft message from the potential affiliate user account 106. The reply can include an acceptance of proposed terms or product-related information selected by the user, which can be delivered to the user based on the product-related information. The messaging interface 116 can also include a recommendation unit for recommending a different potential affiliate user account 106, such as a different user account 106C associated with the present user account 106B. The recommendation can be based on the user's preference information. In an example, the messaging interface 116 can include at least one user-friendly format for accepting or denying an offer. The user-friendly format can include at least one of: a button for accepting or denying the offer; a checkbox for accepting or denying the offer; a graphical user interface (GUI) pop-up menu for accepting or denying the offer; and an option to accept or deny the offer.

In an example, the offer can include terms providing that a distribution right to the UGC item 104 be exchanged for a benefit to the user account 106. For example, the benefit can include a monetary benefit (e.g., cash, value of the benefit paid to the user account 106 in monetary form); a non-monetary benefit (e.g., a promotional opportunity that is provided to the user account 106); or a combined financial/non-monetary benefit (e.g., a financial benefit provided to the user account 106 that is convertible to a non-monetary benefit). The financial benefit can take the form of, for example, an amount of money, credit, goods, and/or services). The non-monetary benefit can take the form of, for example, a promotional opportunity (e.g., a free download, discounted price, etc.); an educational opportunity (e.g., access to an educational application, a training course, a tutorial, a lesson, etc.); or other non-monetary opportunity (e.g., an account-related offer to the user account 106, a content-related offer to the user account 106, a service-related offer to the user account 106, etc.).

In an example, a monetary benefit can be distributed between a plurality of selected user accounts 106 based on at least one weighting. For example, the weighting of an individual user account can be based on a user account follower count, a user account engagement, a user account follower ratio, or a time-period based engagement (e.g., an indication of recent engagement). For example, user accounts 106 that have been recently engaged can be weighted higher than user accounts 106 lacking recent engagement. Further, user accounts 106 may be weighted based on characteristics of the user accounts 106. For example, user accounts 106 can be selected that have been active (e.g., beginning with a first posting a UGC to the dialogic network) for a certain period. Similarly, a user account 106 that has a greater number of followers can be weighted higher than a user account 106 that has a lower number of followers.

An algorithm can be used such as to weight an individual user account 106. In some examples, an individual user account 106 can be weighed based on an input weighted value of the user account 106, the value being input by the user brand profile 102. For example, a weight can be an absolute value, a moving average of the absolute value, or a moving average of the moving average, a weighted value of an individual user account 106 can indicate a rate of change of absolute values (e.g., a rate of change of absolute values over a recent period of time). In some examples, a weight of an individual user account 106 can be derived from at least one characteristic of the individual user account 106 within an environment of the dialogic network. For example, at least one value can be derived from a user account follower count, a user account engagement, a user account follower ratio, a time-period based engagement, or a rate of change of the value. In some examples, a weight of an individual user account 106 can be dependent on a time period, e.g., a rate of change over a time period.

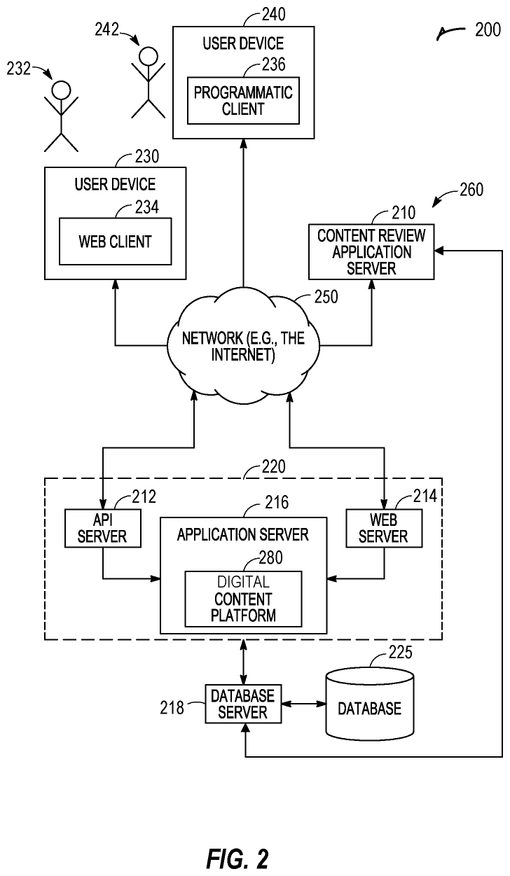

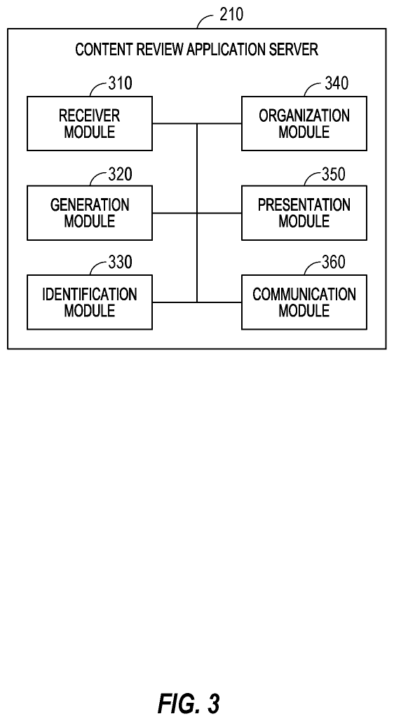

FIG. 2 is a network diagram illustrating a network environment 200 suitable for sharing content, curating recommendations, and distributing the curated recommendations across a social network and across multiple category areas and media units. The network environment 200 includes a content review application server 210, a publication system 220, and user devices 230 and 240, all communicatively coupled to each other via a network 250. The content review application server 210, explained in more detail with reference to FIG. 3, can form all or part of a network-based system 260 configured to receive a set of user interactions performed on a set of data objects, generate a set of associations between the set of data objects, identify a set of data object clusters, generate an organization for the set of data objects, and present a plurality of data objects for display. The data objects may include a media product, such as a UGC item, offered by the publication system 220, described more fully below. For example, the content review application server 210 can be configured to monitor for actions performed by user devices 230 and 240 with respect to the publication system 220. In an example, the content review application server 210 can access the publication system 220 based on user-permitted account pairing. Also, the content review application server 210 can access publicly published UGC the publication system 220 without the need for a user-account permission or authorization.

Although shown as separate from the publication system 220, in some examples, the content review application server 210 can be included in the publication system 220 as a portion thereof. For example, the content review application server 210 can form one or more hardware components in communication with other components of the publication system 220. In some embodiments, the content review application server 210 can form one or more components of the publication system 220, implemented as a combination of hardware and software. For example, software forming a portion of the publication system 220 can include processor executable instructions which configure a processor of the publication system 220 to perform operations of the content review application server 210 described herein.

The publication system 220 is shown as including an application programming interface (API) server 212, a web server 214, an application server 216. Also, the publication system 220 can be communicatively coupled with a database server 218, and a database 225. In some embodiments, the publication system 220 forms all or part of the network-based system 260 (e.g., a cloud-based server system configured to provide one or more content services to the user devices 230 and 240). The content review application server 210, the publication system 220, and the user devices 230 and 240 may each be implemented in a computer system, in whole or in part. The API server 212 provides a programmatic interface by which the user devices 230 and 240 can access the application server 216 of the publication system 220

The application server 216 may be implemented as a single application server 216 or a plurality of application servers. The application server 216, as shown, hosts one or more digital content platforms 280 (e.g., Instagram™, Facebook™, or TikTok™), which comprises one or more modules or applications and which may be embodied as hardware, software, firmware, or any combination thereof. The application server 216 is, in turn, shown to be coupled to the database server 218 that facilitates access to one or more information storage repositories or databases, such as the database 225.

While the client-server-based network environment 200 shown in FIG. 2 employs a user-server architecture, the present disclosure is not limited to such architecture, and may equally well find application in a distributed architecture system (e.g., peer-to-peer), for example. The digital content platform 280 may also be implemented as standalone software programs, which do not necessarily have network capabilities.

The database server 218 is coupled to the database 225 and provides access to the database 225 for the user devices 230 and 240 and other components of the content review application server 210. The database 225 can be a storage device that stores information related to media units, media documents, web sites, and metadata relating to media units, media documents, or websites, and the like.

Also shown in FIG. 2 are users 232 and 242. One or both of the users 232 and 242 can be a human user (e.g., a human being), a machine user (e.g., a computer configured by a software program to interact with the user device 230), or any suitable combination thereof (e.g., a human assisted by a machine, or a machine supervised by a human). The user 232 is not part of the network environment 100, but is associated with the user device 230 and is a user of the user device 230. For example, the user device 230 can be a desktop computer, a vehicle computer, a tablet computer, a navigational device, a portable media device, a smartphone, or a wearable device (e.g., a smart watch or smart glasses) belonging to the user 232. Likewise, the user 242 is not part of the network environment 200 but is associated with the user device 240. As an example, the user device 240 can be a desktop computer, a vehicle computer, a tablet computer, a navigational device, a portable media device, a smartphone, or a wearable device (e.g., a smart watch or smart glasses) belonging to the user 242. Although described as outside of the network environment 200, the network environment can be understood to include data representing an aggregation of user behaviors communicated through user devices associated with the users.

The user device 230 contains a web client 234 which may access the digital content platform 280 via the web interface supported by the web server 214 and, in some cases, the content review application server 210. Similarly, a programmatic client 236 is configured to access the various services and functions provided by the digital content platform 280 via the programmatic interface provided by the API server 212 and, in some cases, the content review application server 210. The programmatic client 236 may, for example, perform batch-mode communications between the programmatic client 236, the network-based system 260, and the content review application server 210. Although the user device 230 is shown with the web client 234 and the user device 240 is shown with the programmatic client 236, it should be understood that both the user device 230 and the user device 240 may each include instances of the web client 234 and the programmatic client 236 specific to the user device 230 or 240 containing the client.

Any of the machines, databases, or devices shown in FIG. 2 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 2 may be combined into a single machine, and the functions described herein for any single machine, database, or device may be subdivided among multiple machines, databases, or devices.

The network 250 may be any network that enables communication between or among machines, databases, and devices (e.g., the content review application server 210 and the user device 230). Accordingly, the network 250 can be a wired network, a wireless network (e.g., a mobile or cellular network), or any suitable combination thereof. The network 250 can include one or more portions that constitute a private network, a public network (e.g., the Internet), or any suitable combination thereof. Accordingly, the network 250 can include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., Wi-Fi network or WiMAX network), or any suitable combination thereof. Any one or more portions of the network 250 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

FIG. 3 is a block diagram illustrating components of the content review application server 210, according to some example embodiments. In example embodiments, the content review application server 210 comprises a receiver module 310, a generation module 320, an identification module 330, an organization module 340, a presentation module 350, and a communication module 360, all configured to communicate with each other (e.g., via a bus, shared memory, or a switch). Any one or more of the modules described herein may be implemented using hardware (e.g., one or more processors of a machine) or a combination of hardware and software. For example, any module described herein may configure at least one processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The receiver module 210 receives sets of user interactions from a plurality of users (e.g., the user 232 of FIG. 2, the user 242 of FIG. 2, and other users) via their respective user devices 230, 240. The sets of user interactions may be performed on a set of data objects, such as user-generated media units, otherwise described herein as UGC. The sets of user interactions may include data relating to interactions between the users 232 and 242 themselves, and/or data relating to interactions between the user 232 or 242 and the digital content platform 280 of FIG. 2, and/or a combination of such interactions. The sets of user interactions are received by the content review application server 210 via the receiver module 310. The sets of user interactions can include or comprise data representative of selections of the user 232 or 242 with respect to the data published by the publication system 220 of FIG. 2 or media units created, uploaded, selected, browsed, accessed, or viewed (in whole or in part) by the users 232 or 242. The data representative of the interactions can include one or more selections or interruptions caused by the user 232 or 242 interacting with a touch screen of the user device 230 or 240 of FIG. 2, a mouse, a keyboard, or other input device capable of enabling user interaction with a user interface of the user device 230 or 240. The receiver module 310 can receive the one or more selections via communication between the user device 230 or 240 and the communication module 360.

The generation module 320 generates a set of associations between data objects of the set of data objects. Each association may be identified among two or more data objects (e.g., between a first data object and a second data object) of the set of data objects. For example, the content review application server 210 may receive indications of user interactions from the user devices of the users, such as the user 232 or the user 242, and/or interactions of the users 232 and 242 with media, such as UGC items, offered by the digital content platform 280 of the publication system 220, or data indicative of the media units. In these embodiments, data indicative of the user interactions of the users 232 and 242 may be transmitted through the content review application server 210 such that the content review application server 210 receives the user interactions prior to passing those interactions to an intended recipient. For example, the content review application server 210 may initially receive one or more packets of data over the network 250, indicative of user interactions of the users 232 and 242. The content review application server 210 can copy, log, or otherwise make records of the user interactions, and then transmit the user interactions to the intended recipient, such as the publication system 220. In some embodiments, the content review application server 210 can receive a copy of the data indicative of the user interactions, for example, by receiving a copy of the packet sent to an intended recipient of the user interactions. In some embodiments, the content review application server 210 may receive data indicative of the user interaction without receiving the user interaction. For example, the content review application server 210 may receive a portion of a data packet or some other data indicative of the content of the user interaction, without receiving the complete transmission associated with the user interaction.

The associations may be indicative of user interactions performed on each of the two or more data objects. For example, the generation module 320 can generate a first set of associations among a first set of data objects and generate a second set of associations among or between the second set of data objects. Further, the generation module 320 can generate a third set of associations between the first set of data objects and the second set of data objects. One or more of the associations in the set of associations may be based on input received from either or both of the users 232 and 242. As described in further detail below, the generation module 320 can also generate a set of associations between data objects based on a classification model.

The generation module 320 can comprise a hardware module, described below in more detail. By way of example, in some embodiments, the generation module 320 can comprise a hardware processor configured to perform the operations relating to the generation of sets of associations among data objects of the set of data objects. The operations for generating the associations among the data objects are described below in more detail. Further still, the generation module 320 can generate curated recommendations based on a set of associations. One or more of the recommendations may be based on input received from either one or both of the users 232 and 242.

The identification module 330 identifies a set of data object clusters indicative of associations of the set of associations among or between data objects of the set of data objects. The identification module 330 can perform graph clustering to identify data object clusters. The data object clusters can be indicative of associations of the set of associations among the data objects.

The organization module 340 can generate an organization for the set of data objects based on the set of associations and the set of data object clusters. The organization module 340 can organize the set of data objects in a logical organization (e.g., on a database) or other non-transitory machine-readable storage medium. The organization module 340 can perform operations of weighting, ranking, and other organizational operations on the set of data objects, as explained in more detail below. In some examples, the content review application server 210 generates an organization for the set of data objects. In some embodiments, the organization is based on the set of associations and the set of data object clusters. For example, the organization can be generated such that data objects having direct associations are linked closely together with other data objects in a given cluster. The organization can also retain a link between data objects more tangentially related, given their respective positions on the graph. The organization of the set of data objects can be both a logical organization on a database or other non-transitory machine-storage medium. In some embodiments, the organization can include weighting and ranking the data objects. Although described with reference to associating, weighting, and ranking of data objects, it will be understood by one skilled in the art that the organization may include or be based on any suitable method for organizing data objects within the set of data object clusters.

The presentation module 350 causes presentation of a plurality of data objects of the set of data objects based on the organization. For example, the presentation module 350 can include the user interface of the content review application 100 (as depicted in FIG. 1A). The presentation module 350 can cause the presentation of the plurality of data objects by transmitting the plurality of data objects and instructions indicative of the organization to the user device 130 or 140. The instructions can cause formatting of the plurality of data objects on the user interface of the user device 130 or 140 according to one or more visualization techniques to present the set of data objects based on the organization. The presentation module 350 can cause the set of data objects to be presented via display on a screen (e.g., in a graphically based representation, a text-based representation, or a combination thereof), via sound transmission (e.g., via voice or simulated voice transmission), or any other suitable method for presentation. Where the presentation module 350 presents the set of data objects on the screen of the user device 230 or 240, the presentation module 350 can cause the user device 230 or 240 to display the set of data objects as a set of representative icons or images, where each icon is representative of a data object of the set of data objects. The icons or images can be presented in a list view, a grid view, or any other suitable arrangement of icons or images.

The communication module 360 enables communication for the content review application server 210. For example, the communication module 360 can enable communication among the receiver module 310, the generation module 320, the identification module 330, the organization module 340, and the presentation module 350. In some embodiments, the communication module 360 can enable communication among the content review application server 310, the user device 230 or 240, and the publication system 220, as well as other systems capable of communicating with the content review application server 210, such as via a communications network (e.g., the internet).

The publication system 220 may store the user interactions in the database 225 or any other suitable non-transitory machine-readable storage medium. In some embodiments, the user interactions may be communicated to the content review application server 210 by the publication system 220, where the user interactions are stored in or in conjunction with the publication system 220.

Further, in some embodiments, the content review application server 210 may be implemented as a portion of the publication system 220. In these embodiments, the user interactions received by the content review application server 210 may be received through the communication module 360, the API server 212, or the application server 216.

In some embodiments, the data object is represented or implemented as a data object file or a data object entry in a database. For example, the data object file or the data object entry may be stored on the database 225 of the publication system 220. The data object file or data object entry may contain metadata or be associated with metadata existing in another file or entry on a database. Each association of the data object can be generated by modifying a portion of metadata included in the data object file or data object entry. Where the metadata is in another file or entry, the metadata of the file or entry may be similarly modified. In some embodiments, a metadata file or entry may be created based on the generation of the association of data objects, instantiating metadata for the data object file or data object entry or replacing a previous metadata file or metadata entry.

The associations can represent interactions between a user and a data object, such as a media product. The associations can include a type of interaction. For example, in conjunction with the digital content platform 280, the type of interaction can include a creation, claim of title, or other indication of authorship from user 232 or user 242. Also, in conjunction with the digital content platform 280, the type of interaction can include a viewing, a labeling, favoriting, rating, or otherwise marking of a data object by user 232 or user 242. In some embodiments, data indicative of the interactions can be stored in a transaction log that can be processed to generate a graph of the associations used in clustering operations, described in more detail below. These graphs can be expressed in a plurality of tables. Such tables include a source node index, a target node index, and a transaction table. The source node index can be indicative of the users performing interactions on the data objects. The target node index can be indicative of an item or category of an item, for example. The transaction table can be indicative of specific actions, such as bidding, buying, watching, or other suitable transactions or interaction types with references to both the source node index and the target node index associated with the individual transactions within the transaction table. The transaction table can be weighted (e.g., by tie strength) by the number of transactions between users and items.

In some embodiments, a metadata file, or metadata entry, can be an association file having a portion of metadata indicative of a relationship between the data object and the association file. The association file can also include data indicative of the associations between data objects, data object files, or data object entries. The association file can be stored on a first non-transitory machine-storage medium which also stores the data object files or data object entries or can be stored on a second non-transitory machine-storage medium. In these embodiments, the first and second non-transitory machine-storage media may be in communication, such as across the network 250. The first and second non-transitory machine-storage medium may additionally include lookup tables, a relational database, or other storage mechanism suitable to contain data relating to related data object files or data object entries of the first and second non-transitory machine-storage medium, for example. In embodiments where the metadata indicative of an association or the association file itself is modified, removed, or created, the lookup tables, relation database, or other storage mechanism may also be modified to reflect the change to the association between two data objects.

The portion of metadata in the metadata of the data object file or data object entry, the metadata file, or the metadata entry indicative of each association can include metadata indicative of a number of other data object files or data object entries associated with the data object file or data object entry. For example, the portion of metadata for a first data object can include an integer value indicative of a number of other data objects associated with the first data object. For instance, if the first data object has six associations distributed among three other data objects, the portion of metadata indicating the number of data objects associated with the first data object may be an integer value of three, indicating the three other data objects.

In some embodiments, the metadata can include a number of associations between the data object file or data object entry, and each of the other data object files or data object entries with which the data object file or data object entry is associated. For example, in the instance above where the first data object is associated with three other data objects (e.g., a second data object, a third data object, and a fourth data object), the metadata including the number of associations for the first data object can include identification values indicative of an identification for each of the second data objects, the third data objects, and the fourth data objects. The metadata can also include an association value corresponding to each identification value. The association value may indicate a number of associations between the first data object and data object of the corresponding identification value. For example, where the two users have interacted with both the first data object and the second data object, the content review application server 210 may determine two associations between the first data object and the second data object. In this example, the association value may be two, for the identification value of the second data object, in the metadata of the first object. In some embodiments, the metadata can include a total number of associations corresponding to the data object file or data object entry. In the example above, the metadata includes a total number of six for indicating the total number of associations between the first data object and the three other data objects.

In some embodiments the organization can be a graphical or user readable organization generated for a graphical user interface. For example, the content review application server 210, such as the organization module 320, may group representations of data objects in a graphical display, indicative of the associations between the data objects and representative of data object clusters. In some embodiments, the content review application server 210 can also distribute data objects found in a data object cluster across a graphical user interface to avoid granting additional weight to a data object cluster within the graphical representation of the organization. In some embodiments, the organization module 340 of the content review application server 210 configures at least one processor of the content review application server 210 to generate the organization for the set of data objects.

In some examples, the content review application server 210 causes presentation of a plurality of data objects of the set of data objects on a user interface of the user device 230, based on the organization. The plurality of data objects can include a set of media units each including or having been associated with a signifier corresponding with a consumer brand marker, the set of data object clusters, and a user input (e.g., a query). In some embodiments, the presentation module 350 configures at least one processor of the content review application server 210 to cause the presentation of the plurality of data objects in a user interface of the user device 230 or 240. In some embodiments, the presentation module 350 receives the plurality of data objects directly from the organization module 340. Alternatively, the presentation module 350 receives the plurality of data objects from the organization module 340 via the communication module 360.

The presentation module 350 can cause the presentation or display of the set of media units, each including or having been associated with a signifier corresponding with a consumer brand marker, on a user interface (e.g., display or other output device) of the user device 230. In some embodiments, the presentation module 350 transmits the plurality of data objects and instructions indicative of the organization by which to display the plurality of data objects in order to present the plurality of data objects for display. For example, the presentation module 350 passes the plurality of data objects and the instructions indicative of the organization to the communication module 360 which then transmits the plurality of data objects and the instructions indicative of the organization to the user device 230. The instructions can be processor executable instructions that cause the user device 230 to display the plurality of data objects.

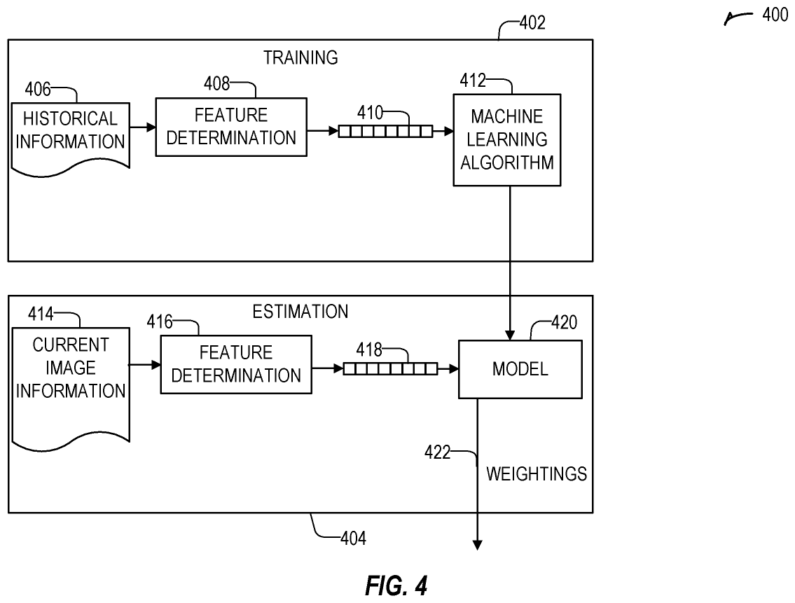

FIG. 4 illustrates an exemplary model machine learning engine 400 for use in identifying relevant user-generated content. The machine learning engine 400 utilizes a training engine 402 and an estimation engine 404. The training engine 402 inputs historical image information 406 (e.g., image features or patterns corresponding to a brand signifier) into feature determination engine 408. The historical image information 406 may be labeled to indicate the correspondence between image features and a brand signifier.

Feature determination engine 408 determines one or more features 410 from this historical image information 406. Stated generally, features 410 are a set of the information input and include information determined to be predictive of a particular outcome. The features 410 may be determined by hidden layers, in an example.

The machine learning algorithm 412 produces a model 420 based upon the features 410 and the labels. The machine learning algorithm 412 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine.

Also, the machine learning algorithm 412 can include or be used with one or more algorithms capable of extracting data from the specimen image, such as data by compression, filtering, edge detection, corner detection, blob detection, ridge detection, Hough transform, image segmentation, optical flow, genetic algorithms (GA), or other techniques for algorithmically analyzing an image. The one or more algorithms can be capable of digital image processing such as to extract relevant data from the specimen image to help enable recognition of features or patterns corresponding to a brand signifier.

In the estimation engine 404, current image information 414 (e.g., a current UGC item to be analyzed for patterns corresponding to a brand signifier) may be input to the feature determination engine 416. Feature determination engine 416 may determine features of the current information 414 to estimate a corresponding state. In some examples, feature determination engines 416 and 408 are the same engine. Feature determination engine 416 produces feature vector 418, which is input into the model 420 to generate one or more criteria weightings 422. The training engine 402 may operate in an offline manner to train the model 420. The estimation engine 404, however, may be designed to operate in an online manner. It should be noted that the model 420 may be periodically updated via additional training or user feedback (e.g., input from a user brand profile indicating relevance of UGC content or correspondence of image features or patterns to a brand signifier).

The model 420 can be an artificial neural network in some implementations. Artificial neural networks are artificial in the sense that they are computational entities, inspired by biological neural networks but modified for implementation by computing devices. Artificial neural networks are used to model complex relationships between inputs and outputs or to find patterns in data, where the dependency between the inputs and the outputs cannot be easily ascertained. A neural network typically includes an input layer, one or more intermediate (“hidden”) layers, and an output layer, with each layer including a number of nodes. The number of nodes can vary between layers. A neural network is considered “deep” when it includes two or more hidden layers. The nodes in each layer connect to some or all nodes in the subsequent layer and the weights of these connections are typically learnt from data during the training process, for example through backpropagation in which the network parameters are tuned to produce expected outputs given corresponding inputs in labeled training data. Thus, an artificial neural network is an adaptive system that is configured to change its structure (e.g., the connection configuration or weights) based on information that flows through the network during training, and the weights of the hidden layers can be considered as an encoding of meaningful patterns in the data.

A fully connected neural network is one in which each node in the input layer is connected to each node in the subsequent layer (the first hidden layer), each node in that first hidden layer is connected in turn to each node in the subsequent hidden layer, and so on until each node in the final hidden layer is connected to each node in the output layer.

The model 420 can include a Support Vector Machine (SVM), K-Nearest Neighbors (KNN), Artificial Neural Network (ANN), or an ensemble model combining the SVM and ANN.

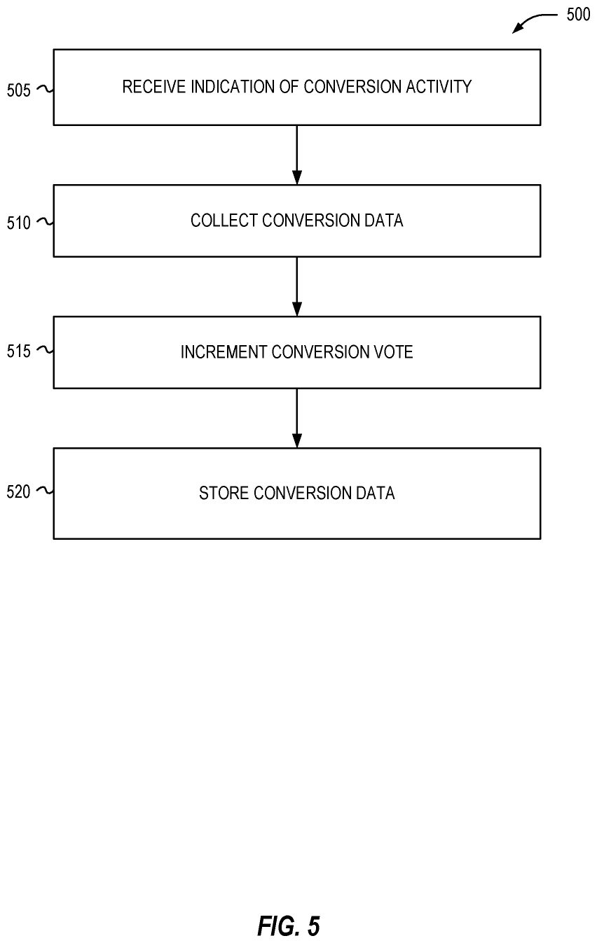

FIG. 5 is a flowchart depicting an example of a process flow (500) to collect conversion data. In an example, conversion data can be received and used to indicate or determine the correspondence between image features and a brand signifier. In an example, the conversion data can be used with the machine learning model 420 (as depicted in FIG. 4) to determine the correspondence between image features and the brand signifier. Also, correspondence between image features and the brand signifier can be based solely on received conversion data. In an example, conversion data can be received by the receiver module 310 (as depicted in FIG. 3). Also, the conversion data can be processed in the identification module 330 to help determine the presence of image features corresponding to the brand signifier. At 505, the content review application server 210 (depicted in FIG. 2) receives an indication of a conversion activity. For example, upon performing a search for a user brand hashtag, a user may select “#userbrand” to access the content review application server 510 and further download a media file from the content review application server 510. In one embodiment, conversion data will generally take the form of associating the initial query (e.g., searching #userbrand), with the user's response to a set of options (e.g., selecting media posts including #userbrand) when that response is followed by a conversion activity (e.g., downloading a media file).

At 510, the content review application server 210, such as at the receiver module 310, receives or collects conversion data describing the conversion. Conversion data collected may include the type of conversion, when the conversion occurred, who performed the conversion, a number of times that a keyword has been associated with a conversion for a document in which it is contained, a number of other documents for which a keyword has converted, a date of the last time the keyword converted for a document, a number of distinct users converting for the keyword, and revenue associated with the conversion, among other examples.

In an example, the content review application server 210 may collect conversion data through tools that track network traffic. For example, the content review application server 210 may identify a query and may assign an identifier to the user that submitted the query, such as when a user arrives through a search engine. This identifier may be a “cookie” that is placed on the user device 240; or, alternatively, it may be an identifier that accompanies the user throughout the conversion activity but does not stay with the user after the visit is concluded, among other methods of tracking user activity. For example, in the case where cookies are used, the digital content platform 280 may be able to track return visits by the user and may make assumptions about the connection between the first visit, subsequent visits, and conversion activity.

Also, in an example the content review application server 210 can store foot traffic or other metrics, such as telephone inquiries, that can be tied to an initial site visit where the connection can be made or inferred. For example, store traffic may be measured by offering a coupon for downloading and redemption at a store.

At 515, the content review application server 210, such as at the organization module 340, increments a conversions vote. The conversions vote is a count of the number of times a conversion associated with the document (or a query) has been performed. The conversion votes may be used to rank and order a search result, as will be further described below.

At 520, the content review application server 210, such as at the organization module 340, stores the conversion data associated with the conversion. In an example, specific elements of the conversion can be stored, such as a converting keyword tag that is used to focus the attention of a ranking mechanism, such as a search engine's algorithm, on the specific element for purposes of contributing to the presentation of that document in response to a query.

Also, in an example, alternative values may define an identification of the search engine that generated the conversion, a specific date history of conversions (e.g., day of the week), an identification of specific rank rather than average, an identification of geographic region from which the query was initiated, an identification of special promotional data offered by the site owner, an identification of user behavior, such as the number of previous visits to the site before converting, and visits to other sites before converting, etc.

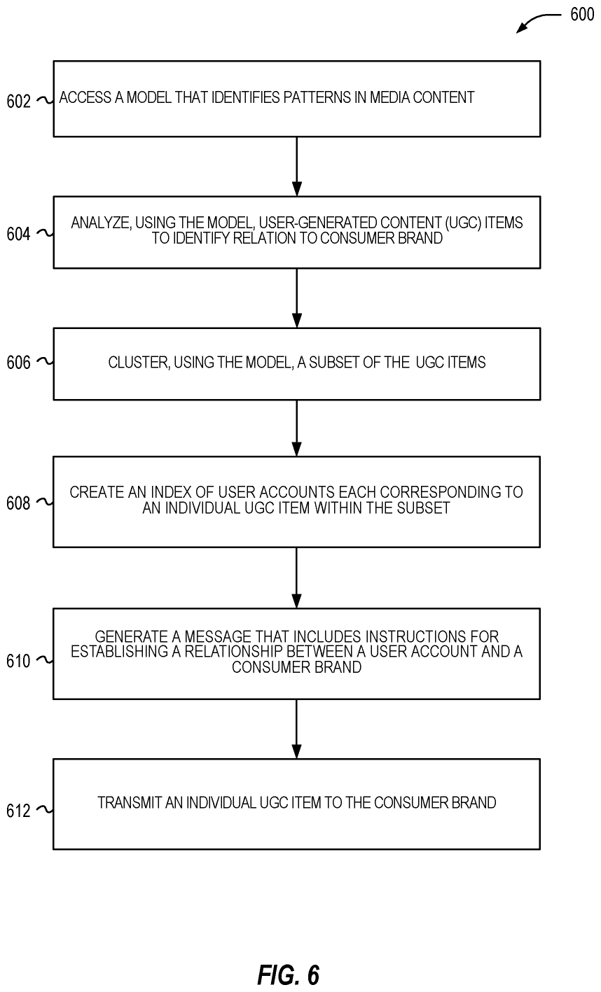

FIG. 6 is a flowchart showing a method 600 of identifying user-generated content related to a consumer brand such as performed within the identification module 330. At operation 602, a model can be accessed, and the model can be able to identify patterns or features corresponding to a consumer brand marker. For example, the model can be a machine learning model. The model can also be algorithmic. In an example, the machine learning model is trained using training data from a second set of UGC items each corresponding with a consumer brand marker. Here, an individual UGC item in the second set of UGC items can be assigned to an individual consumer brand marker.

At operation 604, a first set of user-generated content (UGC) items within a dialogic network can be analyzed, such as using the model, to identify a signifier corresponding with a consumer brand marker. Also, the first set of UGC items can be analyzed based on collected conversion data to identify a signifier corresponding with a consumer brand marker. The UGC items can be identified as related to a consumer brand signifier by identifying signifiers, patterns, or denotations corresponding to a consumer brand marker. For example, the signifier can be a hashtag, a user brand profile reference, or a keyword. Also, the model can identify patterns such as via image recognition and for comparison to a brand signifier such as a brand logo from one or more dialogic networks. The dialogic one or more dialogic networks can include, e.g., Instagram™, TikTok™, Facebook™, Twitter™, Reddit™, Snapchat™, LinkedIn™, YouTube™, or Pinterest™.

At operation 606, a subset of the first set of UGC items including at least two of the plurality of UGC items can be clustered or organized with one another, such as clustered using the model. In an example, the UGC items can be clustered based on their association to the signifier corresponding with the consumer brand marker. Furthermore, the UGC items can be clustered based on two or more different signifiers. Additionally, the UGC items can be clustered based on a confidence of analysis such as for further user confirmation of relevance.

At operation 608, an index of user accounts can be created. Each user account in the index can correspond with an individual UGC item within the subset generated by a respective user account owner.

At operation 610, a message can be generated, such as automatically, and the message can include instructions for establishing a relationship between a user account and a consumer brand.

At operation 612, an individual UGC item from the subset can be transmitted, such as via a monologic network, as an advertisement for the consumer brand. For example, the monologic network can be a network where a brand posts an advertisement and wherein a consumer does not have a commensurate platform for communication with the consumer brand. For example, the UGC item can be transmitted to a brand-account accessible location such as via a network or via storage in a database. For example, an individual UGC item can be obtained via the content downloader 110 (as depicted in FIG. 1A) and stored for later use as a marketing material.

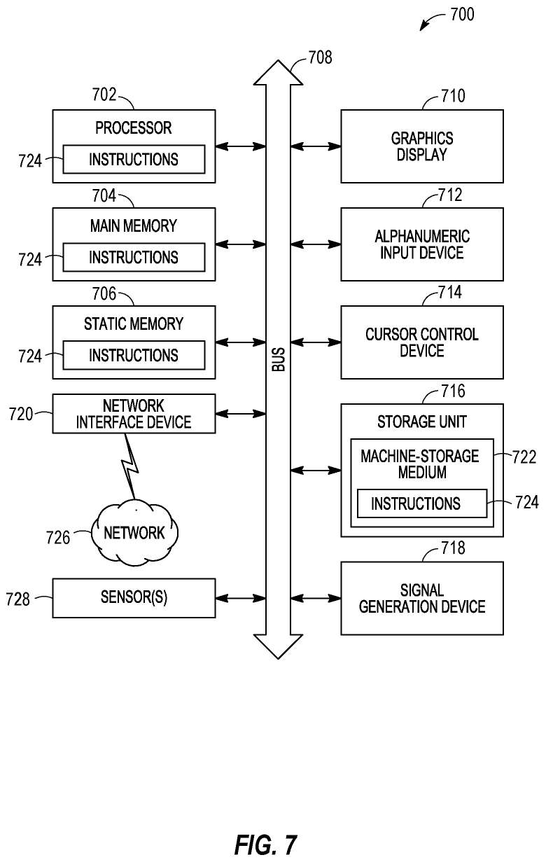

FIG. 7 is a block diagram illustrating components of a machine 700, according to some example embodiments, able to read instructions 724 from a machine-storage medium 722 (e.g., a non-transitory machine-storage medium, a machine-storage medium, a computer-storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part. For example, the instructions 724 can be processor executable instructions that, when executed by a processor of the machine 700, cause the machine 700 to perform the operations outlined above.

In alternative embodiments, the machine 700 operates as a standalone device or may be communicatively coupled (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, an audio generation device 718 (e.g., a sound card, an amplifier, a speaker, a headphone jack, any suitable combination thereof, or any other suitable signal generation device), and a network interface device 720.

The storage unit 716 includes the machine-storage medium 722 (e.g., a tangible and non-transitory machine-storage medium) on which are stored the instructions 724, embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-storage media (e.g., tangible and non-transitory machine-storage media). The instructions 724 may be transmitted or received over the network 726 (or the network 150) via the network interface device 720. For example, the network interface device 720 may communicate the instructions 724 using any one or more transfer protocols (e.g., Hypertext Transfer Protocol (HTTP)).

In some example embodiments, the machine 700 may be a portable computing device, such as a smart phone or tablet computer, and have one or more additional input components (e.g., sensors 728 or gauges). Examples of the additional input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed embodiments.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

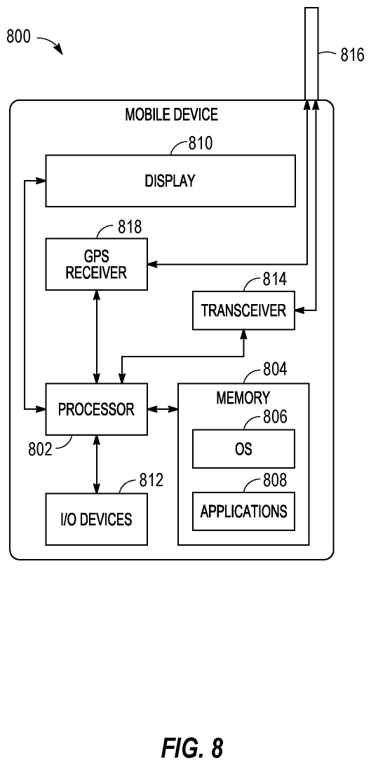

FIG. 8 is a block diagram illustrating a mobile device 800, according to some example embodiments. The mobile device 800 can be an implementation of the user device 230 or 240 of FIG. 2. In some embodiments, the mobile device 800, in communication with the content review application server 210 of FIG. 2 can perform some of the methodologies described herein and can provide input from the user 232 or 242 of FIG. 2 to the content review application server 210. For example, the mobile device 800 may be an implementation of the user device 230 of FIG. 2. The mobile device 800 can include a processor 802. The processor 802 can be any of a variety of different types of commercially available processors suitable for mobile devices 800 (for example, an XScale architecture microprocessor, a Microprocessor without Interlocked Pipeline Stages (MIPS) architecture processor, or another type of processor). A memory 804, such as a random-access memory (RAM), a Flash memory, or other type of memory, is typically accessible to the processor 802. The memory 804 can be adapted to store an operating system (OS) 806, as well as application programs 808, such as a mobile location enabled application that can provide location-based services to a user. The processor 802 can be coupled, either directly or via appropriate intermediary hardware, to a display 810 and to one or more input/output (I/O) devices 812, such as a keypad, a touch panel sensor, a microphone, and the like. Similarly, in some example embodiments, the processor 802 can be coupled to a transceiver 814 that interfaces with an antenna 816. The transceiver 814 can be configured to both transmit and receive cellular network signals, wireless data signals, or other types of signals via the antenna 816, depending on the nature of the mobile device 800. Further, in some configurations, a GPS receiver 818 can also make use of the antenna 816 to receive GPS signals.

The mobile device 800 can be configured to perform at least a portion of any one or more of the methodologies discussed herein. For example, the memory 804 of the mobile device 800 may include instructions comprising a portion of one or more of the receiver modules 210, the generation modules 28, the identification modules 230, the organization modules 240, and the presentation modules 250. For example, one or more of the modules described above can be distributed between the content review application server 210 and the mobile device 800 to perform one or more of the operations outlined above with respect to each module. The modules can configure the processor 802 of the mobile device 800 to perform one or more of the operations outlined above with respect to each module. In some embodiments, the mobile device 800 and the machine 700 of FIG. 7 can each store at least a portion of the modules discussed above and cooperate to perform the methods described above, as will be explained in more detail below.

Example 1 is a method comprising: accessing a model that identifies patterns corresponding to consumer brand markers; analyzing, using the model, a plurality of user-generated content (UGC) items within a dialogic network to identify signifier corresponding with a consumer brand marker; clustering, using the model, a subset of the plurality of UGC items including at least two of the plurality of UGC items; creating an index of user accounts each corresponding to an individual UGC item within the subset generated by a respective user account owner; automatically generating a message that includes instructions for establishing an affiliate-sponsor relationship between an individual user account and the consumer brand, the automatically generated message including a request from the consumer brand for a distribution right of the corresponding UGC item; and transmitting, via a monologic network, an individual UGC item from the subset as an advertisement for the consumer brand in response to acceptance of the request.

In Example 2, the subject matter of Example 1, wherein the automatically generated message includes a request from the consumer brand for a distribution right of the corresponding UGC item.

In Example 3, the subject matter of Example 2, wherein the requested distribution right is an exclusive distribution right to digital media content included in the UGC item.

In Example 4, the subject matter of any of Examples 1-3, wherein the automatically generated message includes at least one automatically generated contractual offer from the consumer brand and to an owner of the individual user account.

In Example 5, the subject matter of Example 4, wherein the contractual offer includes a plurality of manually selectable offers to be selected by the owner of the individual user account.

In Example 6, the subject matter of any of Examples 4-5, wherein the contractual offer includes terms and conditions that govern the offer, the terms and conditions including a time constraint for accepting the contractual offer.

In Example 7, the subject matter of any of Examples 4-6, wherein the contractual offer includes a proposal of a grant to the consumer brand of an distribution right of the corresponding UGC item in exchange for a benefit to the owner of the individual user account.

In Example 8, the subject matter of Example 7, wherein the benefit includes at least one monetary benefit.

In Example 9, the subject matter of any of Examples 7-8, wherein the benefit includes at least one non-monetary benefit including at least one of a promotional opportunity, an educational opportunity, an account-related offer to the user account, a content-related offer to the user account, or a service-related offer to the user account in exchange for the distribution right.

In Example 10, the subject matter of any of Examples 1-9, further comprising valuating, based on user data of the individual user account, a plurality of user accounts within the index of user accounts.

In Example 11, the subject matter of any of Examples 1-10, further comprising: weighting at least one of: each user account within the index of at least one user account relative to each other; or each UGC item within the index of a set of UGC items relative to each other; and disproportionately distributing monetary benefits to an individual user account for UGC item based on at least one respective ranking.

In Example 12, the subject matter of Example 11, wherein a weight of an individual user account is based on at least one characteristic of the individual user account within an environment of the dialogic network, the at least one characteristic including a user account follower count, a user account engagement, a user account follower ratio, a time-period based engagement, or a rate of change of engagement values.

In Example 13, the subject matter of any of Examples 1-12, wherein the automatically generated message includes at least one user-account specific hyperlink to a product from the consumer brand.

In Example 14, the subject matter of Example 13, wherein the user-account specific hyperlink includes hypertext markup language (HTML) directed to a product, service, organization, or marketplace associated with the consumer brand.

In Example 15, the subject matter of any of Examples 1-14, further comprising valuating a plurality of user accounts within the index of user accounts based on at least one digital media attribute of a respective UGC item including: content lightning characteristics including exposure, brightness, contrast, color profile, saturation, vibrance, or white balance; content playback length; a content audio waveform; or at least one shared visual characteristic included in a plurality of UGC items which usage rights are obtained.

In Example 16, the subject matter of any of Examples 10-15, wherein valuating includes determining whether a user account parameter transgresses a threshold for the individual user account within the index of user accounts.

In Example 17, the subject matter of Example 16, wherein the threshold includes: a minimum amount of followers of the individual user account; a minimum amount of UGC posts of the individual user account; a minimum amount of UGC shares of the individual user account; a minimum user account age of the individual user account; a minimum number of follower engagement on the individual user account; a minimum threshold ratio on an engagement count on individual user account's UGC posts to individual user account's follower count ratio; or a verification status of the individual user account.

In Example 18, the subject matter of any of Examples 16-17, further comprising preventing transmission of the automatically generated message to an individual user account lacking an account parameter above the threshold.

Example 19 is a system comprising: one or more hardware processors; and a memory storing instructions that, when executed by the one or more hardware processors, causes the one or more hardware processors to perform operations comprising: accessing a model that identifies patterns corresponding to consumer brand markers; analyzing, using the model, a plurality of user-generated content (UGC) items within a dialogic network to identify signifier corresponding with a consumer brand marker; clustering, using the model, a subset of the plurality of UGC items including at least two of the plurality of UGC items; creating an index of user accounts each corresponding to an individual UGC item within the subset generated by a respective user account owner; automatically generating a message that includes instructions for establishing an affiliate-sponsor relationship between an individual user account and the consumer brand, the automatically generated message including a request from the consumer brand for a distribution right of the corresponding UGC item; and transmitting, via a monologic network, an individual UGC item from the subset as an advertisement for the consumer brand in response to acceptance of the request.

Example 20 is a machine-storage medium including instructions for identifying user-generated content related to a consumer brand, which when executed by one or more processors of a machine, cause the machine to perform operations comprising: accessing a model that identifies patterns corresponding to consumer brand markers; analyzing, using the model, a plurality of user-generated content (UGC) items within a dialogic network to identify signifier corresponding with a consumer brand marker; clustering, using the model, a subset of the plurality of UGC items including at least two of the plurality of UGC items; creating an index of user accounts each corresponding to an individual UGC item within the subset generated by a respective user account owner; automatically generating a message that includes instructions for establishing an affiliate-sponsor relationship between an individual user account and the consumer brand, the automatically generated message including a request from the consumer brand for a distribution right of the corresponding UGC item; and transmitting, via a monologic network, an individual UGC item from the subset as an advertisement for the consumer brand in response to acceptance of the request.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing a model that identifies patterns corresponding to consumer brand markers;
analyzing, using the model, a plurality of user-generated content (UGC) items within a dialogic network to identify signifier corresponding with a consumer brand marker;
clustering, using the model, a subset of the plurality of UGC items including at least two of the plurality of UGC items;
creating an index of user accounts each corresponding to an individual UGC item within the subset generated by a respective user account owner;
automatically generating a message that includes instructions for establishing an affiliate-sponsor relationship between an individual user account and the consumer brand; and
transmitting, via a monologic network, an individual UGC item from the subset as an advertisement for the consumer brand in response to acceptance of the request.

2. The method of claim 1, wherein the automatically generated message includes a request from the consumer brand for a distribution right of the corresponding UGC item.

3. The method of claim 2, wherein the requested distribution right is an exclusive distribution right to digital media content included in the UGC item.

4. The method of claim 1, wherein the automatically generated message includes at least one automatically generated contractual offer from the consumer brand and to an owner of the individual user account.

5. The method of claim 4, wherein the contractual offer includes a plurality of manually selectable offers to be selected by the owner of the individual user account.

6. The method of claim 4, wherein the contractual offer includes terms and conditions that govern the offer, the terms and conditions including a time constraint for accepting the contractual offer.

7. The method of claim 4, wherein the contractual offer includes a proposal of a grant to the consumer brand of an distribution right of the corresponding UGC item in exchange for a benefit to the owner of the individual user account.

8. The method of claim 7, wherein the benefit includes at least one monetary benefit.

9. The method of claim 7, wherein the benefit includes at least one non-monetary benefit including at least one of a promotional opportunity, an educational opportunity, an account-related offer to the user account, a content-related offer to the user account, or a service-related offer to the user account in exchange for the distribution right.

10. The method of claim 1, further comprising valuating, based on user data of the individual user account, a plurality of user accounts within the index of user accounts.

11. The method of claim 1, further comprising:
weighting at least one of:
each user account within the index of at least one user account relative to each other; or
each UGC item within the index of a set of UGC items relative to each other; and
disproportionately distributing monetary benefits to an individual user account for UGC item based on at least one respective ranking.

12. The method of claim 11, wherein a weight of an individual user account is based on at least one characteristic of the individual user account within an environment of the dialogic network, the at least one characteristic including a user account follower count, a user account engagement, a user account follower ratio, a time-period based engagement, or a rate of change of engagement values.

13. The method of claim 1, wherein the automatically generated message includes at least one user-account specific hyperlink to a product from the consumer brand.

14. The method of claim 13, wherein the user-account specific hyperlink includes hypertext markup language (HTML) directed to a product, service, organization, or marketplace associated with the consumer brand.

15. The method of claim 1, further comprising valuating a plurality of user accounts within the index of user accounts based on at least one digital media attribute of a respective UGC item including:
content lightning characteristics including exposure, brightness, contrast, color profile, saturation, vibrance, or white balance;
content playback length;
a content audio waveform; or
at least one shared visual characteristic included in a plurality of UGC items which usage rights are obtained.

16. The method of claim 10, wherein valuating includes determining whether a user account parameter transgresses a threshold for the individual user account within the index of user accounts.

17. The method of claim 16, wherein the threshold includes:
a minimum amount of followers of the individual user account;
a minimum amount of UGC posts of the individual user account;
a minimum amount of UGC shares of the individual user account;
a minimum user account age of the individual user account;
a minimum number of follower engagement on the individual user account;
a minimum threshold ratio on an engagement count on individual user account's UGC posts to individual user account's follower count ratio;
or
a verification status of the individual user account.

18. The method of claim 16, further comprising preventing transmission of the automatically generated message to an individual user account lacking an account parameter above the threshold.

19. A system comprising:
one or more hardware processors; and
a memory storing instructions that, when executed by the one or more hardware processors, causes the one or more hardware processors to perform operations comprising:
accessing a model that identifies patterns corresponding to consumer brand markers;
analyzing, using the model, a plurality of user-generated content (UGC) items within a dialogic network to identify signifier corresponding with a consumer brand marker;
clustering, using the model, a subset of the plurality of UGC items including at least two of the plurality of UGC items;
creating an index of user accounts each corresponding to an individual UGC item within the subset generated by a respective user account owner;
automatically generating a message that includes instructions for establishing an affiliate-sponsor relationship between an individual user account and the consumer brand, the automatically generated message including a request from the consumer brand for a distribution right of the corresponding UGC item; and
transmitting, via a monologic network, an individual UGC item from the subset as an advertisement for the consumer brand in response to acceptance of the request.

20. A machine-storage medium including instructions for identifying user-generated content related to a consumer brand, which when executed by one or more processors of a machine, cause the machine to perform operations comprising:
accessing a model that identifies patterns corresponding to consumer brand markers;
analyzing, using the model, a plurality of user-generated content (UGC) items within a dialogic network to identify signifier corresponding with a consumer brand marker;
clustering, using the model, a subset of the plurality of UGC items including at least two of the plurality of UGC items;
creating an index of user accounts each corresponding to an individual UGC item within the subset generated by a respective user account owner;
automatically generating a message that includes instructions for establishing an affiliate-sponsor relationship between an individual user account and the consumer brand, the automatically generated message including a request from the consumer brand for a distribution right of the corresponding UGC item; and
transmitting, via a monologic network, an individual UGC item from the subset as an advertisement for the consumer brand in response to acceptance of the request.
